(19) United States
(12) Patent Application Publication
(10) Pub. No.: US 2004/0263121 A1
(43) Pub. Date: Dec. 30, 2004

(54) Charge balancing circuit for double-layer capacitors

(75) Inventor: Guy C. Thrap, Del Mar, CA (US)

Correspondence Address: FOLEY & LARDNER, P.O. BOX 80278, SAN DIEGO, CA, 92138-0278, US

(73) Assignee: Maxwell Technologies, Inc.

(21) Appl. No.: 10/819,262

(22) Filed: May 20, 2004

Related U.S. Application Data
(63) Continuation-in-part of application No. 10/423,708, filed on Apr. 25, 2003, now Pat. No. 6,806,686.
(60) Provisional application No. 60/518,052, filed on Nov. 7, 2003.
(60) Provisional application No. 60/518,421, filed on Nov. 7, 2003.
(60) Provisional application No. 60/498,197, filed on Aug. 26, 2003.

(51) Int. Cl. H02J 7/00

(52) U.S. Cl. 320/119

(57) ABSTRACT

A charge balancing circuit is configured to provide charge balancing for a bank of series connected charge storage devices. One embodiment of the charge balancing circuit comprises a voltage divider, an amplifier, and a negative feedback resistor connected between every two capacitors. The circuit is configured to monitor the voltage in each of the capacitors and, if the voltage in one of the capacitors is higher than the other, the circuit transfers energy from the higher charged capacitor to the lower charged capacitor until the capacitors are balanced. A current limiting resistor can be included for limiting the output current of the amplifier to a safe value and for providing feedback information regarding the health of the capacitor. An additional gain stage can also be included for increasing the output current of the amplifier for banks of large charge storage devices. The circuit can be used in bi-polar applications.

### RELATED APPLICATIONS

This application is related to and claims priority from commonly assigned U.S. Patent Application No. 60/518,052 filed 7 Nov. 2003, Attorney Docket M104P, which is incorporated herein by reference;

This application is related to and claims priority from commonly assigned U.S. Patent Application No. 60/518,421 filed 7 Nov. 2003, Attorney Docket M107P, which is incorporated herein by reference.

This application is related to and claims priority from commonly assigned U.S. Patent Application No. 60/498,197 filed 26 Aug. 2003, Attorney Docket 026471-0591, which is incorporated herein by reference; and

This application claims priority from and is a continuation-in-part application of commonly assigned U.S. patent application Ser. No. 10/423,708 filed 25 Apr. 2003, Attorney Docket 026471-0501, which is incorporated herein by reference.

### FIELD OF THE INVENTION

This invention relates to charge balancing electronic circuitry. More specifically, this invention relates to low cost, linear charge balancing circuits that automatically balance voltages between two or more charge storage devices connected in series.

### BACKGROUND OF THE INVENTION

When series connected charge storage devices are used with power source voltages that are higher than an individual device's rating, the devices may begin to accept charge at different rates. One type of charge storage device is a capacitor cell. When series connected capacitor cells are used, a cell's different rate of charge may cause an over voltage imbalance to appear across one or more cell and, consequently, to cause a catastrophic failure to occur in that cell. When using series connected capacitor cells that are rated to operate at high voltage, the cells can typically be used without considering over voltage, as well as charge balancing. This result derives from the fact that high voltage capacitor cells may be provided with ratings that exceed the power source voltages used in most applications. For example, consideration of voltage imbalances between series connected electrolytic capacitors rated to operate at hundreds or even thousands of volts can reduced or eliminated when lesser voltage power sources are utilized with such capacitors.

There is a type of high capacitance capacitor known as a double-layer capacitor (also known as a super-capacitor and a double-layer capacitor). Individual double-layer capacitor cells can, however, be operated only at relatively low voltages, for example, on the order of about 4 volts and below. In one embodiment, a nominal operating voltage of a double-layer capacitor cell is in a range of about 2.5 to 3 volts. Double-layer capacitors can be connected in series to provide operation at higher voltages. Because double-layer capacitors need to be operated at relatively low voltages, the potential for application of over-voltage to such capacitors by a same or higher rated voltage power supply is greatly increased and, thus, needs to be considered.

A number of complicated solutions have been proposed to protect against capacitor overcharge and over voltage. For example, one such solution uses diode-type devices, such as zener diodes, to shunt a series connected capacitor in a bank when an individual capacitor reaches a predetermined threshold voltage. The value of each diode-type device must be specifically selected for each particular application to match the predetermined threshold for that application. This inflexibility presents design and manufacture problems in that each new application may require a different diode value. In other words, each diode-based system is customized to a particular application. Once the capacitor is charged to the predetermined threshold, the diode-type device causes any continuing charging current to be shunted around the capacitor protecting the capacitor from overcharging.

The diode-type device solution, while capable of providing overcharging protection, is imperfect. For example, usable diode-type devices typically do not provide a perfect shunt around the capacitor. As such, the devices dissipate energy, typically in the form of heat. This dissipated energy is wasted energy in that it is not being used to charge capacitors. The heat created during energy dissipation can cause overheating problems in certain applications. Another disadvantage of diode-type devices is that even after all capacitors in a bank have been charged, they continue to draw current. This continual current draw leads to additional wasted energy. Thus, it is difficult, and indeed in many cases impossible, to build a standard diode-based charge balancing circuit that can be used with different sets of series connected capacitors.

Another proposed solution includes a passive resistive bridge arranged in a predetermined configuration. Like the diode-type devices described above, resistive bridges also suffer from various disadvantages in their implementation. For example, resistive bridges typically leak substantial amounts of energy and, like diode-type devices, continue to leak energy even after the capacitors in the bank are fully charged. In addition, resistive bridges substantially slow down the time required to charge a capacitor bank.

More recently, a charge balancing solution has utilized complicated microprocessor-driven circuits that monitor such things as the charge and/or the charge/discharge rate of each individual capacitor in a bank, as well as the overall charge of the entire bank. These circuits typically include switching logic, inductors, and/or other components that can be controlled by the microprocessor to protect each individual capacitor from being over charged. One major disadvantage of such microprocessor-driven circuits is that they are complex and expensive devices. While microprocessor-driven circuits provide monitoring, recording and tracking capabilities that are typically not found in the other solutions mentioned above, these additional capabilities are often duplicative of capabilities already available in the end user application in which the capacitors are applied. Thus, the added expense and complexity associated with microprocessor driven charge balancing circuits is unnecessarily wasteful. Another disadvantage is that microprocessor-driven solutions typically come with a high quiescent current. To minimize energy waste caused by the high quiescent current, the microprocessor must be capable of being turned off when it is not needed. The control logic needed for turning the microprocessor on and off at the appropriate time further increases the expense and complexity of microprocessor-driven circuits.

Thus, there is a need for a simple, inexpensive, and flexible charge balancing circuit that minimizes energy waste while providing over voltage protection for individual low voltage rated series connected capacitor cells.

### SUMMARY OF THE INVENTION

These and other needs are satisfied by a charge balancing circuit according to the present invention. In one embodiment, a charge balancing circuit comprises an amplifier, a voltage divider, and a feedback connection. In one embodiment, a charge balancing circuit according to the present invention can be configured for balancing two series connected charge storage devices, for example, capacitors or capacitor cells. In one embodiment, capacitors cells comprise double-layer technology. One or more charge-balancing circuit as described herein can be “stacked” to provide charge balancing and over voltage protection for a bank of any length series string of capacitors. In one embodiment, the voltage divider is configured to equally divide the charge voltage across the capacitors in the bank and to provide an input to an amplifier. In one embodiment, the amplifier is configured as an operational amplifier. A negative feedback resistor is configured to provide feedback information to another input of the operational amplifier, with the feedback information related to the voltage of the capacitors. In this manner, if the voltage of one of the capacitors is higher than the voltage of the other capacitor, the inputs to the operational amplifier may become unbalanced. The operational amplifier is configured to provide an output current when the voltage divider input and feedback input do not match and, thus, to cause energy from a capacitor having a higher voltage to be transferred to a capacitor having a lower voltage.

In one embodiment, the voltage divider comprises two divider resistors connected to an input of the operational amplifier. The divider resistors are of approximately the same value and the value of the resistors is high enough to minimize the quiescent current of the circuit. Also, the value of the negative feedback resistor can be approximately half that of the divider resistors so that the negative feedback resistor can cancel any input bias current supplied to the operational amplifier.

A current limiting resistor can also be included between the operational amplifier output and the capacitors. The current limiting resistor can be configured to limit the output current of the operational amplifier to a safe level. The voltage drop across the current limiting resistor can also provide information regarding the health of the capacitors being balanced by the charge balancing circuit. For example, the voltage drop across each current limiting resistor can be compared to the average voltage drop of all of the current limiting resistors. If the voltage drop of any current limiting resistor is significantly higher than the average, a problem may exist with one of the capacitors being serviced by the current limiting resistor.

In one embodiment, a charge balancing apparatus for providing charge balancing of at least two double-layer capacitor cells connected in series, with the at least two cells capable of being charged by a supply voltage, comprises: a voltage divider for equally dividing the supply voltage across the at least two double-layer capacitor cells; a circuit having inputs and an output, the output for connecting between each of the at least two double-layer capacitor cells, the circuit being connected to the voltage divider such that the voltage divider provides a voltage to an input of the circuit; a feedback connection for providing feedback regarding a stored voltage in each of the at least two double-layer capacitor cells to an input of the circuit; wherein the circuit is configured to produce an output current when the stored voltage of a first of the at least two double-layer capacitor cells is higher than the stored voltage of a second of the at least two double-layer capacitor cells, the output current for causing energy stored in the first cell to be transferred to the second cell until the at least two cells are balanced. In one embodiment, the supply voltage is less than about 4 volts x the number of cells connected in series.

In one embodiment, a charge balancing apparatus provides charge balancing of at least two charge storage devices capable of being charged by a supply voltage, the charge balancing apparatus comprising: a voltage divider for equally dividing the supply voltage across the at least two charge storage devices; a circuit having inputs and an output, the output for connecting between each of the at least two charge storage devices, the circuit being connected to the voltage divider such that the voltage divider provides a voltage to an input of the circuit; a feedback connection for providing feedback regarding a stored voltage in each of the at least two charge storage devices to an input of the circuit; wherein the circuit is configured to produce an output current when the stored voltage of a first of the at least two charge storage devices is higher than the stored voltage of a second of the at least two charge storage devices, the output current causing energy stored in the first charge storage device to be transferred to the second charge storage device until the at least two charge storage devices are balanced. In one embodiment, the charge balancing apparatus comprises a current limiting device connected between the circuit and the at least two charge storage devices, the current limiting device being configured to limit the output current of the circuit to a safe value. In one embodiment, the charge balancing apparatus comprises a gain stage for increasing the output current of the circuit. In one embodiment, the voltage divider ftuther comprises two divider resistors of approximately the same value connected to the circuit. In one embodiment, the two divider resistors are of a value high enough to minimize the quiescent current draw of the apparatus. In one embodiment, the feedback connection is configured to cancel any input bias current supplied to the circuit by the voltage divider. In one embodiment, the feedback connection provides a value of approximately half the value of each of the two divider resistors such that the feedback connection effectively cancels any input bias current supplied to the circuit. In one embodiment, the current limiting device has a value equal to the supply voltage divided by the maximum output current of the circuit. In one embodiment, a voltage drop across the current limiting device can be used to provide information regarding the health of the at least two charge storage devices. In one embodiment, each gain stage comprises an amplifier circuit connected between the circuit output and the at least two charge storage devices. In one embodiment, the amplifier circuit comprises two transistors that include a base, emitter and collector and wherein the bases and emitters of each of the two transistors are connected together. In one embodiment, the amplifier circuit comprises two transistors, wherein the two transistors form a complementary symmetry emitter follower transistor pair. In one embodiment, a current limiting device is connected between the gain stage and the at least two charge storage devices, the current limiting device being configured to limit the output current of the gain stage to a safe value. In one embodiment, the current limiting device has a value based on the supply voltage, the saturation current of the amplifier circuit, and the maximum current rating of the amplifier circuit. In one embodiment, the charge storage devices are double-layer capacitors.

In one embodiment, a charge balancing circuit for balancing a voltage between two series connected capacitors comprises: an amplifier having an output, the output for connecting between the two capacitors, wherein the amplifier is configured to produce an output current when a stored voltage of a first of the two series connected capacitors is higher than a stored voltage of a second of the at least two series connected capacitors, the output current for causing energy stored in the first capacitor to be transferred to the second capacitor until the two capacitors are balanced. In one embodiment, the amplifier comprises inputs and a feedback connection, wherein the circuit is configured to provide feedback regarding the stored voltage in the two series connected capacitors to an input of the amplifier. In one embodiment, the circuit comprises a voltage divider for equally dividing a circuit supply voltage across the two series connected capacitors. In one embodiment, the capacitors are double-layer capacitors. In one embodiment, the amplifier is configured as an operational amplifier. In one embodiment, the circuit comprises a voltage divider for equally dividing an alternating current supply voltage across the two series connected capacitors. In one embodiment, the charge balancing circuit is bipolar. In one embodiment, the circuit can be used interchangeably and without modification between two or more sets of the two series connected capacitors.

In one embodiment, a charge balancing device comprises: balancing means for balancing a voltage between two series connected capacitors, wherein the balancing means is configured to produce an output current when a stored voltage of a first of the two series connected capacitors is higher than a stored voltage of a second of the two series connected capacitors, the output current for causing energy stored in the first capacitor to be transferred to the second capacitor until the two capacitors are balanced. In one embodiment, the capacitors are double-layer capacitors.

In one embodiment, a method of balancing a voltage comprises the steps of: providing a set of series connected capacitors providing a first voltage; providing a circuit; providing the first voltage across the series connected capacitors and across the circuit; providing a feedback of a second voltage at a connection of the set of series connected capacitors; and balancing the second voltage using the circuit based on the feedback. In one embodiment, the set of series connected capacitors are double-layer capacitors. In one embodiment, the first voltage does not exceed about 4 volts times the number of series connected capacitors. In one embodiment, the method further comprises the step of providing a circuit that can be used interchangeably without any modification between the two or more sets of series connected capacitors.

In one embodiment, a capacitor product comprises: a housing; two series connected capacitor cells housed within the housing; and a charge balancing circuit operatively coupled to the capacitor cells. In one embodiment, the housing comprises a sealed housing, and wherein the capacitor cells and the charge balancing circuit are disposed within the sealed housing. In one embodiment, the capacitor cells comprise double-layer capacitor cells. In one embodiment, one or more selective enabling and disabling circuit are coupled to the charge balancing circuit and the capacitor cells. In one embodiment, the product is rated to operate safely between a voltage of about 4.0 volts and 9.0 volts. In one embodiment, the charge balancing circuit comprises an amplifier having a high output impedance, the output connected between the two capacitor cells, wherein the amplifier is configured to produce an output current when a stored voltage of a first of the two capacitor cells is higher than a stored voltage of a second of the two capacitor cells, the output current for causing energy stored in the first capacitor cell to be transferred to the second capacitor cell until the two capacitors are balanced.

The charge balancing circuit described herein is flexible in that the individual component values do not have to be tied to the specific values of the capacitors they are serving. Thus, a charge balancing circuit according to the present invention can be applied interchangeably in different applications using different value capacitor banks without having to redesign the circuit. Furthermore, standardization of a design that utilizes inexpensive off the shelf components allows mass production of the present charge balancing circuit at a reduced cost. Furthermore, connection of the charge balancing circuit described herein can be made without having to take into account polarities of the circuit or connection voltage.

Other embodiments and other advantages and benefits derived therefrom will become apparent from a reading of the Figures, Description, and claims that follow.

### BRIEF DESCRIPTION OF THE DRAWINGS

FIG. 1 is a side view of a capacitor bank including interconnecting capacitors having charge balancing circuits according to the present invention.

FIG. 2 is an electrical schematic diagram of a charge balancing circuit according to the present invention.

FIG. 3 is an electrical schematic diagram of the capacitor bank and charge balancing circuits of FIG. 1.

FIG. 4 is an electrical schematic diagram of the capacitor bank and charge balancing circuits of FIG. 1.

FIG. 5 illustrates an electrical schematic diagram of a bi-polar charge balancing circuit.

FIG. 6 illustrates a cross-sectional view of a charge balancing circuit used with two capacitor cells.

### DETAILED DESCRIPTION OF THE PREFERRED EMBODIMENTS

In accordance with the present invention, a charge balancing circuit apparatus is described that provides distinct advantages when compared to that of the prior art. The invention can best be understood with reference to the accompanying drawings and figures.

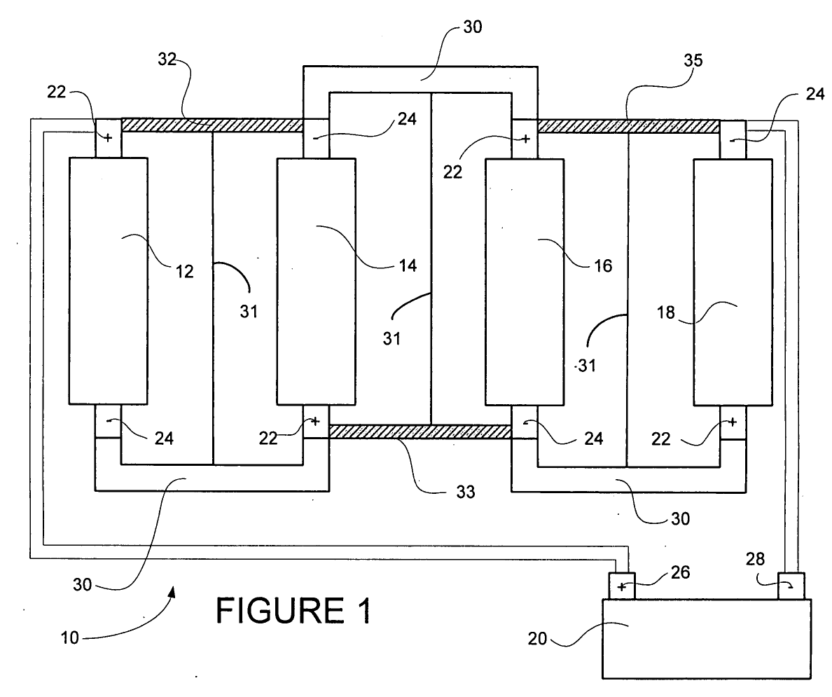

Referring now to FIG. 1, there is shown a bank 10 of four interconnected double-layer capacitors 12, 14, 16, and 18 (also known as ultra-capacitors and super-capacitors). Double-layer-capacitors are known to those skilled in the art and are not described with any further particularity other than needed to describe the aspects and advantages of the invention herein. A DC charging device 20 is connected across the bank 10 and is configured to charge the double-layer capacitors 12, 14, 16, and 18. Each double-layer capacitor 12, 14, 16, and 18 may be labeled to indicate a positive terminal 22 and a negative terminal 24. The charging device 20 also includes a positive terminal 26 and a negative terminal 28.

The double-layer capacitors 12, 14, 16, and 18 are connected together in series by bus bars 30. Each bus bar 30 connects the negative terminal 24 of one double-layer capacitor (12 for example) to the positive terminal 22 of the adjacent double-layer capacitor (14 for example). Charge balancing circuits 32, 33, and 35 according to the present invention are connected between the positive terminal 22 of one double-layer capacitor (12 for example), the negative terminal 24 of the adjacent double-layer capacitor (14 for example), and the opposite bus bar 30 connecting the two double-layer capacitors (12 and 14 for example, through conductor 31).

The charging device 20 is configured to provide a voltage (V_{charge}) across the double-layer capacitor bank 10. This voltage (V_{charge}) is used to provide energy to the double-layer capacitors 12, 14, 16, and 18, which is stored in each double-layer capacitor 12, 14, 16, and 18 until the double-layer capacitors 12, 14, 16, and 18 are fully charged. The positive terminal 26 of the charging device 20 is connected to the positive terminal 22 of the first double-layer capacitor 12 in the bank 10 and the negative terminal 28 of the charging device 20 is connected to the negative terminal 24 of the last double-layer capacitor 18 in the bank 10.

As described above, one concern in charging a bank of charge storage devices such as double-layer capacitors, is that one or more of the charge storage devices may become over charged due to an imbalance in the retained charge or charge rate of the device. This overcharging can cause the device to catastrophically fail. Charge balancing circuits 32, 33, and 35 according to the present invention distribute the energy evenly across each of the capacitors 12, 14, 16, and 18 in the bank 10. A charge balancing circuit according to the present invention protects against inadvertent overcharging due to an imbalance of energy between the capacitors 12, 14, 16, and 18. In other words, as long as a prorata portion of the energy for each double-layer capacitor does not exceed the voltage rating of the capacitor in a bank, a charge balancing circuit according to the present invention protects against overcharging by maintaining an energy balance between the capacitors.

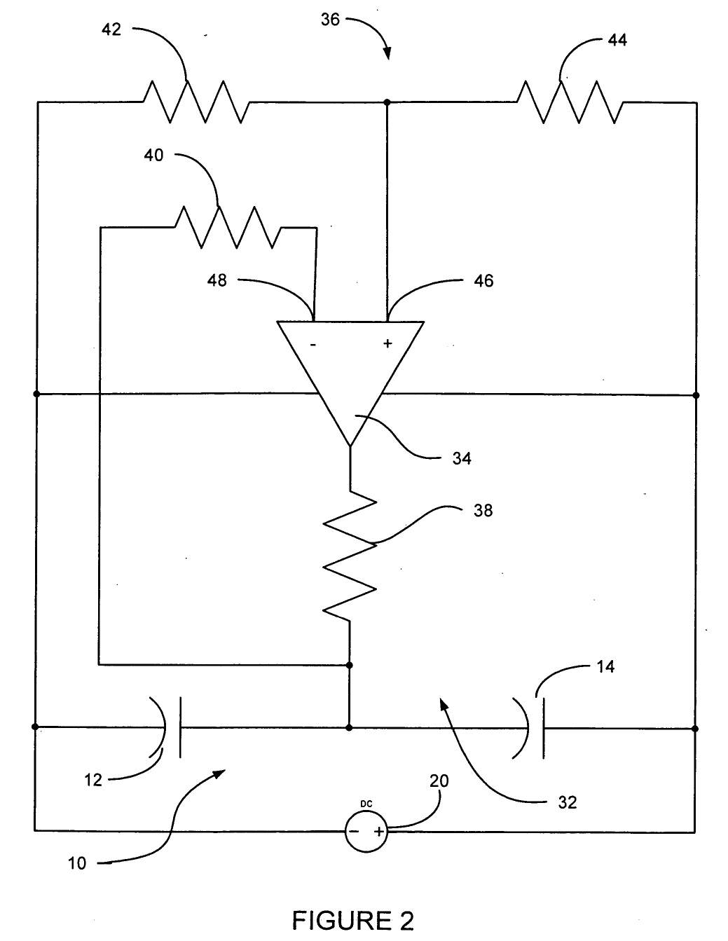

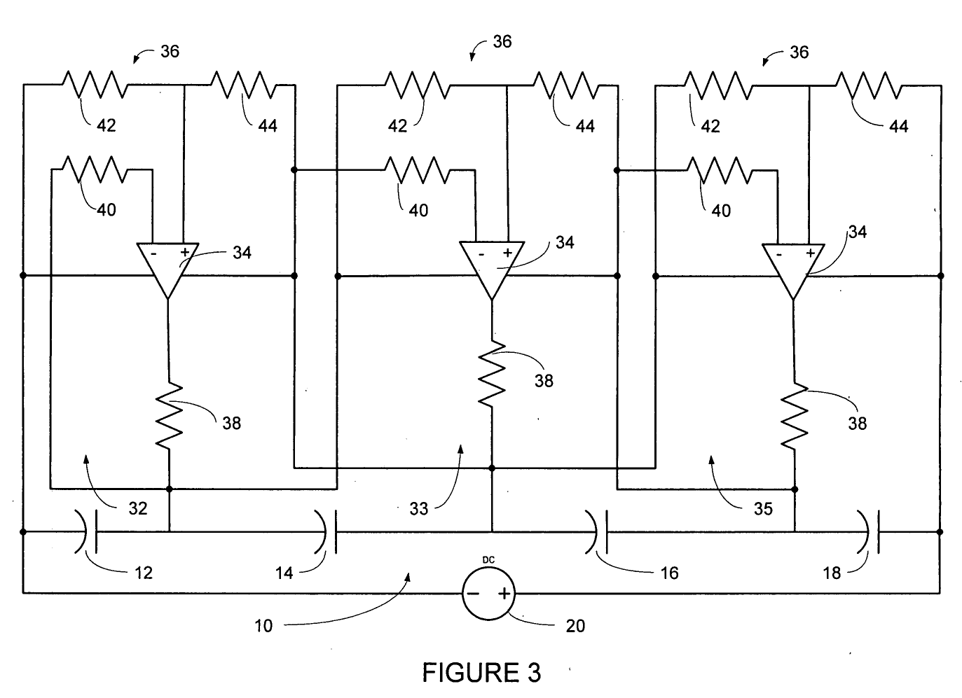

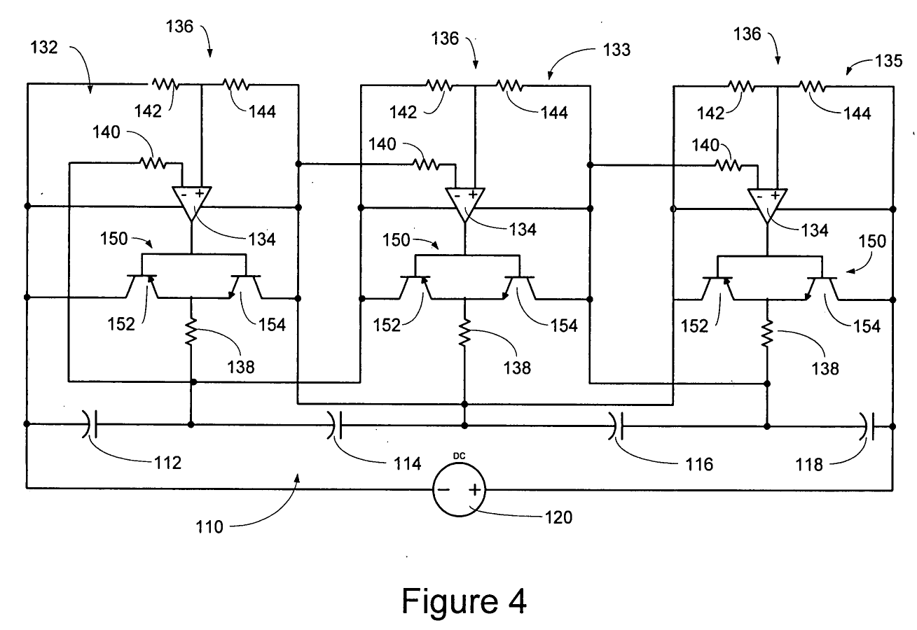

FIG. 2 is an electrical schematic diagram of one embodiment of a single charge balancing circuit 32 according to the present invention configured to provide charge balancing for a bank 10 comprising two capacitors 12 and 14. A charge device 20 is connected across the bank 10 and is configured to provide energy for charging the capacitors 12 and 14 in the bank 10. The charge balancing circuit 32 is configured to force the voltage across each of the capacitors 12 and 14 to be equal. As described in more detail below with respect to FIGS. 3 and 4, charge balancing circuits, such as the one shown in FIG. 2, can be “stacked” to provide charge balancing for banks of capacitors, which have more than two capacitors. In one embodiment of the invention, n−1 charge balancing circuits can be “stacked” together to provide charge balancing for n series connected capacitors.

The charge balancing circuit 32 itself may comprise a circuit 34, which in one embodiment may comprise a high impedance operational amplifier of a type known to those skilled in the art; a voltage divider 36; a current limiting device 38, such as limiting resistor; and a feedback connection 40, such as negative feedback resistor. In one embodiment, the voltage divider 36 comprises two resistors 42 and 44 configured to divide the supply voltage (V_{charge}) of the charging device 20 in half so that half the supply voltage (V_{charge}) is applied to the non-inverting input 46 of the circuit 34. As described in more detail below, by applying half the supply voltage (V_{charge}), the charge balancing circuit 34 according to the present invention can ensure that the supply voltage (V_{charge}) is distributed equally across each of the capacitors 12 and 14 so that neither capacitor 12 and 14 becomes overcharged.

The current limiting resistor 38 is an optional component of charge balancing circuit 32 and is configured to limit the output current of the circuit 34 to a safe level. Limiting the output current of the circuit 34 can be used to prevent the circuit from overheating or from other potentially damaging effects, which could shorten the life of the circuit. In addition, the current limiting resistor 38 can be used for diagnostic and monitoring functions as described in more detail below.

The negative feedback resistor 40 is configured to monitor the voltage at the midpoint between capacitors 12 and 14 and provide a feedback voltage to an inverting input 48 of the circuit 34. This midpoint voltage can be used to determine if the energy stored in capacitors 12 and 14 is equal or unbalanced. If a situation arises in which one of the capacitors (12 for example) is charged more than the other capacitor (14 for example), the circuit 34 will sink or source current so as to cause energy to be transferred from the higher charged capacitor (12 for example) to the lower charged capacitor (14 for example). As the capacitors 12 and 14 approach an identical charge level, the feedback voltage provided to the inverting input 48 of the circuit 34 by the negative feedback resistor 40 will begin to approach the voltage supplied to an non-inverting input 46 of the circuit 34 by the voltage divider 36. As the input voltages on both the non-inverting 46 and inverting 48 inputs of the circuit 34 become equal, the output current of the operation amplifier 34 approaches zero.

The resistors 42 and 44 comprising the voltage divider 36 may be preselected to have relatively high resistances in order to minimize current draw. For example, in the embodiment shown in FIG. 2, with a supply voltage (V_{charge}) of 5v, resistors 42 and 44 could be 1 MΩ resistors. The value of resistors 42 and 44 is selected so that the current drawn across each resistor 42 and 44 when the capacitors 12 and 14 are fully charged is less than the leakage current of the capacitors 12 and 14. In this manner, once the capacitors 12 and 14 are fully charged, the current drawn by the resistors 42 and 44 has little or no effect on the quiescent current of the circuit 34. In order to divide the supply voltage (V_{charge}) in half, resistors 42 and 44 should be of approximately equal value.

Ideally, the negative feedback resistor 40 has a value of approximately one half that of resistors 42 and 44, so that the negative feedback resistor 40 can work to differentially cancel any input bias current supplied to the circuit 34. In the example discussed herein, the value of negative feedback resistor 40 is approximately 500 kΩ. The value of the current limiting resistor 38 can be selected to protect the circuit 34 from damage if one of the capacitors 12 and 14 becomes a short circuit. In order to do so, the value of the current limiting resistor 38 is selected so that the maximum drive current of the circuit 34 remains within a safe range. Using the example discussed herein, with a 10 mA operational amplifier 34 and a 5 v supply voltage, the value of the current limiting resistor 38 is approximately 500 Ω (5 v/10 mA). A typical capacitor which could be used as capacitors 12 and 14 of the FIG. 2 is a 10 farad capacitor. Those skilled in the art will identify that use of individual capacitor cells that utilize double-layer physics and chemistry, limits safe application of voltage to such individual cells to no more than about 4 volts. Thus, in one embodiment, when balancing a voltage between two series connected double-layer capacitors, a voltage applied across the two capacitors should be no more than about 8 volts (4 volts across each capacitor). In a nominal application, however, a voltage applied across two double-layer capacitor cells should be no more than about 5 to 6 volts (about 2.5 to 3 volts across each capacitor). In other embodiments, wherein a greater number of double-layer capacitors are connected in a series string of n capacitors, the voltage across such a string should be appropriately limited so as not to exceed about (4×n) volts. Thus, referring to FIG. 2, in one embodiment, the charge device 20 is limited to provide an output voltage of no more than about 8 volts. In one embodiment, the charge device 20 is limited to provide an output voltage of no more than about 5 to 6 volts. Those skilled in the art would understand that circuit 34, as well other components, could be accordingly designed and sized for optimal operation with a particular charging device 20 output voltage.

It should be noted that the above described embodiment of the charge balancing circuit 32 is flexible in that the individual component values do not have to be tied to the specific values of the capacitors they are serving. Thus, unlike some of the solutions discussed in the background of the invention, a charge balancing circuit according to the present invention can be interchangeably used in different applications with different value series connected capacitors without having to redesign the circuit. Furthermore, the standardization of a design that utilizes inexpensive off the shelf components allows mass production of the present charge balancing circuit at a reduced cost.

FIG. 3 illustrates an electrical schematic diagram of the bank 10 of capacitors 12, 14, 16, and 18 shown in FIG. 1. As can be seen from FIGS. 1 and 3, three charge balancing circuits 32, 33, and 35, according to the present invention, can be used to charge balance the four capacitors 12, 14, 16, and 18. Balancing circuit 32 is configured for balancing capacitors 12 and 14, balancing circuit 33 is configured for balancing capacitors 14 and 16, and balancing circuit 35 is configured for balancing capacitors 16 and 18.

Each balancing circuit 32, 33, and 35, comprises a circuit 34, a voltage divider 36, a current limiting resistor 38, and a negative feedback resistor 40. Each voltage divider 36 can comprise two resistors 40 and 42 configured to equally divide the voltage across the capacitors serviced by the balancing circuit. Each balancing circuit 32, 33, and 35 can function as described with reference to FIG. 2. FIG. 3 also shows how the balancing circuits 32, 33, and 35 can be “stacked” together. In one embodiment, supply device 20 is configured to provide a supply voltage of approximately 10 volts to charge capacitors 12, 14, 16, and 18.

In one embodiment, the current limiting resistors 38 can also provide monitoring and diagnostic functions. For example, the voltage drop across each of the current limiting resistors 38 can provide some information as to the health or an operating characteristic of the capacitors being serviced by each particular charge balancing circuit. By comparing the voltage drop across each individual current limiting resistor 38 to the average voltage drop across the current limiting resistors it is possible to detect problem capacitors even though the bank may appear to be functioning properly.

If the voltage drop across one of the current limiting resistors is significantly higher than the average voltage drop, this could indicate that one of the capacitors being serviced by the charge balancing circuit is on the verge of failure. Even though the capacitor may appear to functioning properly, the fact that it requires an excessive current draw to charge could indicate a problem with the capacitor. Thus, valuable information regarding the health of the each of the capacitors 12, 14, 16, and 18, can be gained by monitoring the voltage drop across each of the current limiting resistors 38.

This diagnostic and monitoring capability could be implemented in the end-user application by using a monitoring circuit, for example, by a microprocessor and a software program configured to receive and process the current limiting resistor voltage drop data to determine an average voltage drop. In one embodiment, such a monitoring circuit can also be configured to trigger a warning or alarm if a problem is detected. Alternatively, if the end user application does not have this capability, a monitoring circuit could be added to the present invention.

FIG. 4 illustrates an alternative embodiment of a charge balancing circuit according to the present invention. In banks employing large capacitors, such as 50 farad or higher value capacitors, it may be desirable to provide an additional gain stage to the charge balancing circuit shown in FIGS. 2 and 3. For example, large capacitors generally have a higher leakage current and it may be desirable to use a gain stage to compensate for the higher leakage current. In addition, a gain stage can be used to reduce the time needed to fully balance the voltages on large capacitors. FIG. 4 illustrates one example of a charge balancing circuit that includes a gain stage for providing charge balancing for banks employing large capacitors.

FIG. 4 illustrates a bank 110 of four capacitors 112, 114, 116, and 118 connected in series with three charge balancing circuits 132, 133, and 135 included for providing charge balancing for the capacitors 112, 114, 116, and 118. A charging device 20 is connected across the bank 110 and is configured to provide energy for charging the capacitors 112, 114, 116, and 118. The charge balancing circuits 132, 133, and 135 are configured to force the voltage across each of the capacitors 112, 114, 116, and 118 to be equal.

Each charge balancing circuit 132, 133, and 135 comprises a circuit 134, a voltage divider 136, a current limiting resistor 138, a negative feedback resistor 140, and a gain stage 150. Each voltage divider 136 comprises two resistors 142 and 144 configured to equally divide the supply voltage across the capacitors 112, 114, 116, and 118 in the bank 110. Each gain stage 150 comprises an amplifier circuit such as transistors 152 and 154, which in one embodiment form a complimentary emitter-follower transistor pair. In the embodiment shown in FIG. 4, the transistor 152 comprises a p-n-p emitter follower transistor and transistor 154 comprises a n-p-n emitter-follower transistor. The bases and emitters of the transistors 152 and 154 are tied together; the collector of one transistor 152 is tied to the negative rail; and the collector of the other transistor 154 is tied to the positive rail.

FIG. 4 circuit 134 works similar to that of circuit 34 of FIG. 3 above, however, in FIG. 4, the output of the circuit 134 is used to drive the gain stage 150. The gain stage 150 can be used to increase the maximum current output of the circuit 134. For example, if circuit 134 is rated at 10 ma, the gain stage 150 can be configured to increase the deliverable current by using 300 ma transistors 152 and 154. Preferably, the transistors 152 and 154 can be configured to compensate for the worst case current leakage of capacitors 112, 114, 116, and 118.

One example of the embodiment illustrated in FIG. 4 can include a 10 ma operational amplifier 134, 100 kΩ resistors 142 and 144 in the voltage divider 136, a 50 Ω negative feedback resistor 140, and a 5.6 Ω current limiting resistor 138. In this embodiment, the capacitors are 2800 farad capacitors and the voltage supply device 20 is configured to supply 10 volts. Because the leakage current of the large capacitors discussed in this example is much higher than the leakage current of the capacitors discussed with respect to the example relating to FIG. 2, 100 kΩ resistors can be used for resistors 142 and 144. Even though 100 kΩ resistors draw more current then the 1 MΩ resistors discussed with respect to the example values used for the embodiment shown in FIG. 2, this additional current is masked by the higher leakage current of the capacitors and thus has little or no effect on the quiescent current of the circuit 134.

The value of the current limiting resistor 138 can be designed for protecting transistors 152 and 154 by taking into consideration the saturation voltages of the transistors 152 and 154. Preferably, the value of the current limiting resistor 138 is calculated based on the supply voltage (V_{charge}), the maximum current rating of the transistors 152 and 154 (Iₘₐₓ), and the saturation voltages of the transistors 152 and 154 (V_{be}+V_{ce sat}). In the example discussed above, the value of the current limiting resistor 138 is calculated using the following equation: (V_{charge}/2)−(V_{be}+V_{ce sat})/Iₘₐₓ.

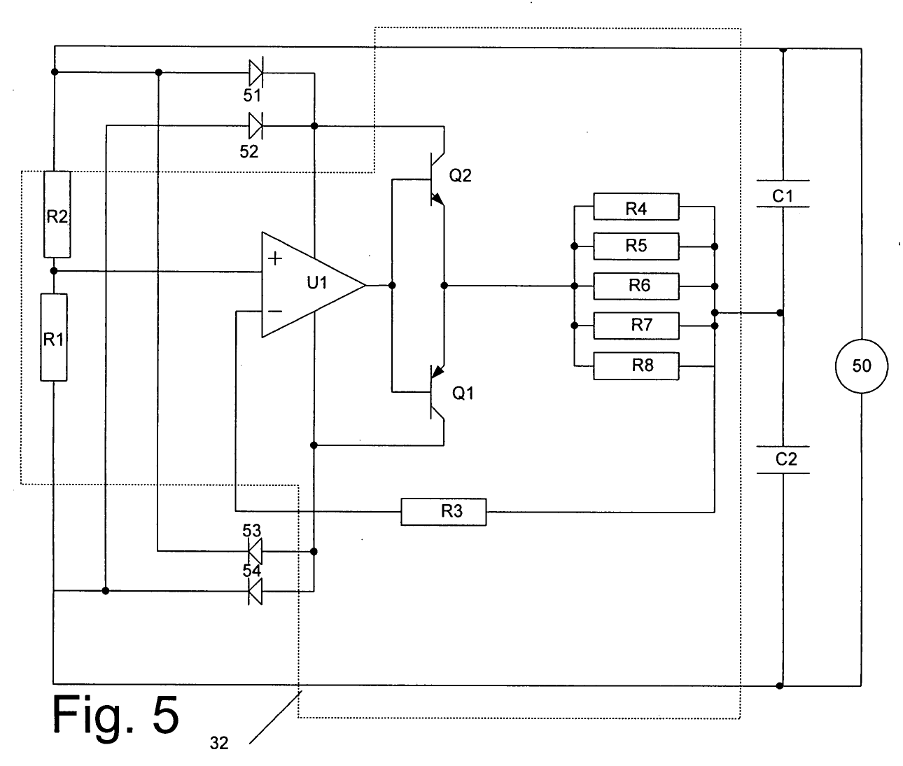

FIG. 5 illustrates another embodiment of a charge balancing circuit according to the present invention. It is identified that one or more of the embodiments described above are applicable for use in single polarity applications. For example, as illustrated in FIG. 2, a direct current (DC) charging device 20 with a fixed positive and negative polarity is connected across two series connected capacitors 12 and 14. A charge balancing circuit 32 is connected across and between the two series connected capacitors 12 and 14 to maintain a balanced voltage at the series connection of the two capacitors. Those skilled in the art will identify that a reversal of the positive and negative polarity connections of the DC charging device 20 would cause permanent damage to the circuit 34 and, thus, make circuit 32 unsuitable for use in an alternating current (AC) voltage application, wherein the polarity of a charging device could change many times per unit of time. Those skilled in the art will also identify that the same type of damage would also occur if, rather than by reversing the polarity connections of the charging device 20, the charge balancing circuit 32 was to be connected backwards across the capacitors 12 and 14, for example, such that the output voltage of a DC charging device 20 was reversed across circuit 34.

In FIG. 5, it is identified that a converter circuit of a type known to those skilled in the art may be provided such that a charge balancing circuit may be connected as a bipolar charge balancing circuit across and between series connected capacitors in either a forward or backward configuration. In one embodiment, the converter circuit comprises 4 diodes 51, 52, 53, 54, with anode portions of two diodes 53 and 54 connected to the negative supply pins of circuit U1 and with cathode portions of two diodes 51 and 52 connected to positive supply pins of circuit U1. In one embodiment, wherein a gain stage is utilized, for example a gain stage comprised of a complimentary emitter-follower transistor pair Q1, Q2, the converter circuit could be connected to the gain stage as well. By providing a converter circuit, the polarity across circuit U1 and/or a gain stage may be maintained with a constant value, such that permanent damage to circuit U1 and the gain stage is avoided. Those skilled in the art would understand that when a converter circuit as described is used between the charging device 50 and a circuit U1 and/or power gain stage power pins, an AC or DC supply voltage supplied by a charging device 50 could be, thus, applied to respective power pins with the proper polarity independent of a forward or backward connection of the charge balancing circuit 32 to series connected capacitors C1, C2. Thus, an end user connection of a charge balancing circuit 32 would need not take into account a polarity of the circuit U1 and/or gain stage, making such connection of the charge balancing circuit much easier and safer as the connection of the circuit would be less susceptible to end user error.

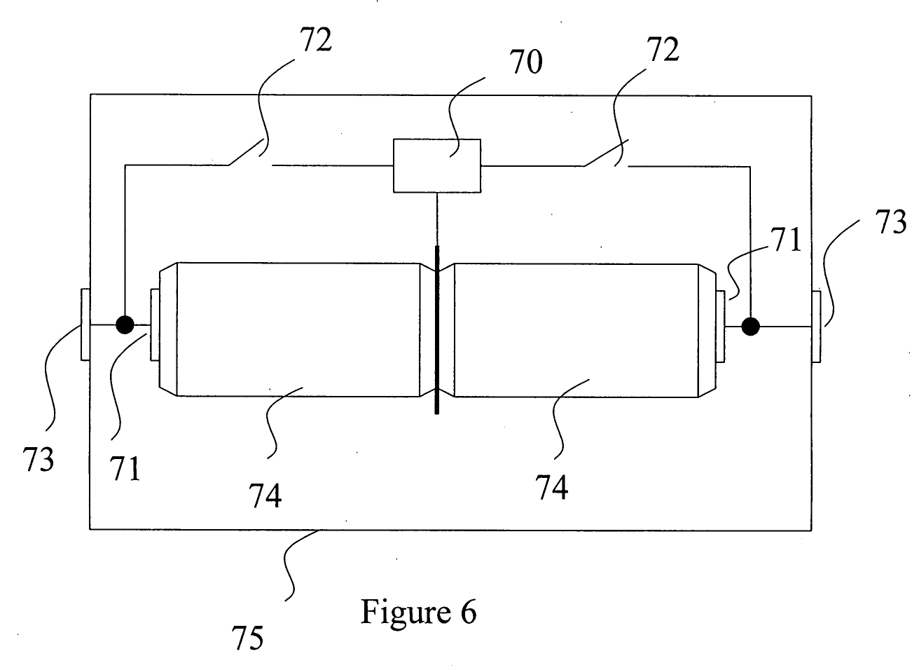

FIG. 6 illustrates a cross-sectional view of a charge balancing circuit used with two capacitor cells. The charge balancing circuit described herein is capable of being manufactured in a very small form factor and very cheaply, allowing it to be used in applications that up to now have not been practical. In one embodiment, in accordance with aspects and advantages described herein, a charge balancing circuit 70 may be coupled to two series connected capacitor cells 74 at a central series connection and to ends of the two series connected capacitor cells 74 at respective capacitor electrode end portions 71. In one embodiment, the two series connected capacitor cells 74 and charge balancing circuit 70 may be coupled to, or housed within, a capacitor housing 75, with capacitor electrode end portions 71 coupled to respective capacitor housing electrode end portions 73. It is identified that with a charge balancing circuit 70 coupled to, or mounted within, a capacitor housing 75, operation of the charge balancing circuit may be made to appear transparent to an end user. With a charge balancing circuit 70 and two series connected capacitors 74 provided within a capacitor housing 75, series connected capacitor cells may be utilized without an end user needing to manual connect the two cells 74 and the charge balancing circuit 70 together. In embodiments, wherein use of a charge balancing circuit 70 is necessitated for safety reasons, for example, when using series connected capacitor cells 74 in high voltage applications (i.e. above the rated voltage of an individual capacitor cell) use of pre-connected series cells 74 and charge balancing circuit 70 would obviate the need for instructing an end user as to proper connection and use thereof. However, in some applications, wherein a capacitor product includes a charge balancing circuit 70 and two or more capacitor cells within a capacitor housing 75, a charge balancing circuit may not be needed. Thus, in one embodiment, two capacitor cells 74 and charge balancing circuit 70 may include one or more selective enabling and disabling circuit 72. In one embodiment, selective enabling and disabling circuit 72 could be provided by one or more switch (shown in an open condition) that enables one or more on/off connections between the charge balancing circuit 70 and the capacitor cells 74. In one embodiment, housing 75 comprises a sealed housing, whereby, the housing is sealed to enclose the one or more capacitor cells 74 and the charge balancing circuit. 70. In and embodiment, wherein a circuit 72 is used within a sealed housing, selective on-off enabling of the circuit could be effectuated by a hall-effect device, or the like.

Although specific resistor, amplifier, capacitor, supply voltage, and transistor values and types are discussed herein, the present invention should not limited by the values listed herein. The above examples are meant only to be illustrative of possible implementations of the present invention as specific component values and types can vary greatly from the ones used in the above examples without departing from the spirit and scope of the invention. In addition, although the particular systems and methods herein shown and described in detail are fully capable of attaining the above described object of this invention, it is understood that the description and drawings presented herein represent some, but not all, embodiments of the invention and are therefore representative of only some of the subject matter which is broadly contemplated by the present invention. For example, resistors described herein may be implemented using surface mount, thru hole, and other components known by those skilled in the art; circuits may be implemented by those skilled in the art using other circuits, operational amplifiers, amplifiers, transistors, resistors, and other components know to those skilled in the art; and transistors, may be implemented using amplifiers, FETs, NPN, PNP, and other components known to those skilled in the art. It is also envisioned that one or more components disclosed herein may implemented in analog form or digital form, including as PLD, firmware, or software implementations.

Thus, it is further understood that the scope of the present invention fully encompasses other embodiments that may become obvious to those skilled in the art and that the scope of the present invention is accordingly limited only by the appended claims.

What is claimed is:

1. A bi-polar charge balancing apparatus for providing charge balancing of at least two double-layer capacitor cells connected in series, the at least two double-layer capacitor cells capable of being charged by a supply voltage, the charge balancing apparatus comprising:
a voltage divider for equally dividing the supply voltage across the at least two double-layer capacitor cells;
a circuit having inputs and an output, the output for connecting between each of the at least two double-layer capacitor cells, the circuit being connected to the voltage divider such that the voltage divider provides a voltage to an input of the circuit;
a feedback connection for providing feedback regarding a stored voltage in each of the at least two double-layer capacitor cells to an input of the circuit;
wherein the circuit is configured to produce an output current when the stored voltage of a first of the at least two double-layer capacitor cells is higher than the stored voltage of a second of the at least two double-layer capacitor cells, the output current for causing energy stored in the first cell to be transferred to the second cell until the at least two cells are balanced.

2. The charge balancing apparatus of claim 1, wherein the supply voltage is less than about 4 volts x the number of cells connected in series.

3. A charge balancing apparatus for providing charge balancing of at least two charge storage devices connected in series, the at least two charge storage devices capable of being charged by a supply voltage, the charge balancing apparatus comprising:
a voltage divider for equally dividing the supply voltage across the at least two charge storage devices;
a circuit having inputs and an output, the output for connecting between each of the at least two charge storage devices, the circuit being connected to the voltage divider such that the voltage divider provides a voltage to an input of the circuit;
a feedback connection for providing feedback regarding a stored voltage in each of the at least two charge storage devices to an input of the circuit;
wherein the circuit is configured to produce an output current when the stored voltage of a first of the at least two charge storage devices is higher than the stored voltage of a second of the at least two charge storage devices, the output current causing energy stored in the first charge storage device to be transferred to the second charge storage device until the at least two charge storage devices are balanced.

4. The charge balancing apparatus of claim 3 further comprising a current limiting device connected between the circuit and the at least two charge storage devices, the current limiting device being configured to limit the output current of the circuit to a safe value.

5. The charge balancing apparatus of claim 3 further comprising a gain stage for increasing the output current of the circuit.

6. The charge balancing apparatus of claim 3 wherein the voltage divider further comprises two divider resistors of approximately the same value connected to the circuit.

7. The charge balancing apparatus of claim 6 wherein the two divider resistors are of a value high enough to minimize the quiescent current draw of the apparatus.

8. The charge balancing apparatus of claim 3 wherein the feedback connection is configured to cancel any input bias current supplied to the circuit by the voltage divider.

9. The charge balancing apparatus of claim 7 wherein the feedback connection provides a value of approximately half the value of each of the two divider resistors such that the feedback connection effectively cancels any input bias current supplied to the circuit.

10. The charge balancing apparatus of claim 4 wherein the current limiting device has a value equal to the supply voltage divided by the maximum output current of the circuit.

11. The charge balancing apparatus of claim 4 wherein a voltage drop across the current limiting device can be used to provide information regarding the health of the at least two charge storage devices.

12. The charge balancing apparatus of claim 5 wherein each gain stage comprises an amplifier circuit connected between the circuit output and the at least two charge storage devices.

13. The charge balancing apparatus of claim 12 wherein the amplifier circuit comprises two transistors that include a base, emitter and collector and wherein the bases and emitters of each of the two transistors are connected together.

14. The charge balancing apparatus of claim 12 wherein the amplifier circuit comprises two transistors, and wherein the two transistors form a complementary symmetry emitter follower transistor pair.

15. The charge balancing apparatus of claim 12 further comprising a current limiting device connected between the gain stage and the at least two charge storage devices, the current limiting device being configured to limit the output current of the gain stage to a safe value.

16. The charge balancing apparatus of claim 15 wherein the current limiting device has a value based on the supply voltage, the saturation current of the amplifier circuit, and the maximum current rating of the amplifier circuit.

17. The charge balancing apparatus of claim 3, wherein the charge storage devices are double-layer capacitors.

18. A charge balancing circuit for providing charge balancing of n charge storage devices connected in series, wherein n is greater than or equal to 2, the n charge storage devices capable of being charged by a supply voltage, the charge balancing circuit comprising:
n−1 voltage dividers for equally dividing the supply voltage across the n charge storage devices;
n−1 amplifiers having inputs and an output, each amplifier being connected at its output between two charge storage devices and each amplifier being connected to one of the n−1 voltage dividers such that each voltage divider provides a voltage to an input of an amplifier;
n−1 feedback connections, each feedback connection connected to one of the n−1 amplifiers, the n−1 feedback connection for providing feedback regarding stored voltage in the n charge storage devices to an input of one of the n−1 amplifiers;
wherein each amplifier is configured to produce an output current when the stored voltage at a first of the two charge storage devices to which it is connected is higher then the stored voltage at a second of the two charge storage devices to which it is connected, the output current causing energy stored in the first charge storage device to be transferred to the second charge storage device until the two charge storage devices are balanced.

19. The charge balancing circuit of claim 18, wherein the supply voltage does not exceed about four times the number of charge storage devices.

20. A charge balancing circuit for balancing a voltage between two series connected capacitors, comprising:
an amplifier having an output, the output for connecting between the two capacitors, wherein the amplifier is configured to produce an output current when a stored voltage of a first of the two series connected capacitors is higher than a stored voltage of a second of the at least two series connected capacitors, the output current for causing energy stored in the first capacitor to be transferred to the second capacitor until the two capacitors are balanced.

21. The circuit of claim 20, wherein the amplifier comprises inputs and a feedback connection, wherein the circuit is configured to provide feedback regarding the stored voltage in the two series connected capacitors to an input of the amplifier.

22. The circuit of claim 21, wherein the circuit comprises a voltage divider for equally dividing a circuit supply voltage across the two series connected capacitors.

23. The circuit of claim 20, wherein the capacitors are double-layer capacitors.

24. The circuit of claim 20, wherein the amplifier is configured as an operational amplifier.

25. The circuit of claim of claim 20, wherein the circuit comprises a voltage divider for equally dividing an alternating current supply voltage across the two series connected capacitors.

26. The circuit of claim 25, wherein the circuit includes a converter circuit and wherein the circuit is a bipolar circuit.

27. The circuit of claim 25, wherein the circuit can be used interchangeably and without modification between two or more sets of the two series connected capacitors.

28. A charge balancing device, comprising:
balancing means for balancing a voltage between two series connected capacitors, wherein the balancing means is configured to produce an output current when a stored voltage of a first of the two series connected capacitors is higher than a stored voltage of a second of the two series connected capacitors, the output current for causing energy stored in the first capacitor to be transferred to the second capacitor until the two capacitors are balanced.

29. The charge balancing device of claim 28, wherein the capacitors are double-layer capacitors.

30. A method of balancing a voltage, comprising the steps of:
providing a set of series connected capacitors providing a first voltage;
providing a circuit;
providing the first voltage across the series connected capacitors and across the circuit;
providing a feedback of a second voltage at a connection of the set of series connected capacitors; and
balancing the second voltage using the circuit based on the feedback.

31. The method of claim 30, wherein the set of series connected capacitors are double-layer capacitors.

32. The method of claim 31, wherein the first voltage does not exceed about 4 volts times the number of series connected capacitors.

33. The method of claim 30, further comprising the step of providing a circuit that can be used interchangeably without any modification between the two or more sets of series connected capacitors.

34. A capacitor product, comprising:
a housing;
two series connected capacitor cells housed within the housing; and
a charge balancing circuit operatively coupled to the capacitor cells.

35. The capacitor product of claim 34, wherein the housing comprises a sealed housing, and wherein the capacitor cells and the charge balancing circuit are disposed within the sealed housing.

36. The capacitor product of claim 34, wherein the capacitor cells comprise double-layer capacitor cells.

37. The capacitor product of claim 35, further comprising one or more selective enabling and disabling circuit coupled to the charge balancing circuit and the capacitor cells.

38. The capacitor product of claim 36, wherein the product is rated to operate safely between a voltage of about 4.0 volts and 9.0 volts.

39. The capacitor product of claim 34, wherein the charge balancing circuit comprises an amplifier having a high impedance, the output connected between the two capacitor cells, wherein the amplifier is configured to produce an output current when a stored voltage of a first of the two capacitor cells is higher than a stored voltage of a second of the two capacitor cells, the output current for causing energy stored in the first capacitor cell to be transferred to the second capacitor cell until the two capacitors are balanced.
